(19) United States
(12) Patent Application Publication
(10) Pub. No.: US 2024/0345324 A1
(43) Pub. Date: Oct. 17, 2024

(54) OPTICAL FIBER MOUNTS FOR PRINTED CIRCUIT BOARDS AND INTEGRATED CIRCUIT DEVICE PACKAGES

(71) Applicant: Intel Corporation, Santa Clara, CA (US)

(72) Inventors: Benjamin Duong, Phoenix, AZ (US); Kristof Darmawikarta, Chandler, AZ (US); Soham Agarwal, Chandler, AZ (US); Marcel Said, Beaverton, OR (US); Sandeep Gaan, Phoenix, AZ (US)

(73) Assignee: Intel Corporation, Santa Clara, CA (US)

(21) Appl. No.: 18/133,353

(22) Filed: Apr. 11, 2023

(51) Int. Cl. G02B 6/26

(52) U.S. Cl. CPC G02B 6/26

(57) ABSTRACT

An integrated circuit package includes a substrate with an integrated circuit device mounting surface, and at least one optical fiber mount in the substrate. The optical fiber mount includes a support having at least one optical fiber mounting channel, and the optical fiber mounting channel is configured to mount at least one clad optical fiber.

### TECHNICAL FIELD

Embodiments described herein generally relate to substrates for mounting multiple integrated circuit devices. The substrates provide optical coupling between the integrated circuit devices mounted thereon, as well as optical coupling to other integrated circuit devices and substrates.

### BACKGROUND

An integrated circuit device (IC), which may also be referred to as a die, chip, microchip or microelectronic circuit, is a semiconductor wafer on which thousands or millions of tiny resistors, capacitors, diodes and transistors are fabricated. In some examples, an IC can function as an amplifier, oscillator, timer, counter, logic gate, computer memory, microcontroller or microprocessor.

Circuit boards for mounting ICs have been made from organic materials such as, for example, glass fiber reinforced epoxy or phenolic resins. To achieve increasingly aggressive input/output (I/O) speed targets, some integrated circuit packages utilize optical interconnect technology. Signal transmission via optics allows higher signal frequencies, which can become lossy along metal conductors.

The use of optical signaling increases signal frequency and digital modulation schemes, which can increase data transfer and bandwidth. However, providing optical signaling between multiple ICs on a circuit board has proved to be difficult and expensive. Circuit board designs and assembly techniques are needed to provide optical coupling between ever-increasing numbers of ICs mounted on the circuit board at an increasingly small pitch.

### BRIEF DESCRIPTION OF THE DRAWINGS

FIG. 1A is a schematic cross-sectional view of an example embodiment of a multi-chip package including optical fiber arrays.

FIG. 1B is a schematic representation of a 2×12 optical fiber array mounted in a circuit board.

FIG. 2A is a schematic, cross-sectional view of an example embodiment of a multi-chip package according to the present disclosure.

FIG. 2B is a schematic, cross-sectional view, taken along line A-A of FIG. 2A, of an example embodiment of an optical fiber mount of the present disclosure.

FIG. 2C is a schematic, cross-sectional view, taken along line A-A of FIG. 2A, of an example embodiment of an optical fiber mount of the present disclosure.

FIG. 2D is a schematic, overhead view, taken along line B-B of FIG. 2C, of an example embodiment of an optical fiber mount of the present disclosure.

FIGS. 3A-3C are schematic, cross-sectional views of example embodiments of optical fiber mounts according to the present disclosure.

FIG. 4 shows a flow diagram of a method of manufacture of a dielectric optical fiber mount in accordance with some example embodiments.

FIG. 5 shows a flow diagram of a method of manufacture of a dielectric optical fiber mount in accordance with some example embodiments.

FIG. 6 shows a flow diagram of a method of manufacture of a dielectric optical fiber mount in accordance with some example embodiments.

FIG. 7 shows a flow diagram of a method of manufacture of a dielectric optical fiber mount in accordance with some example embodiments.

FIG. 8 shows a flow diagram of a method of manufacture of an optical fiber mount with conductive traces in accordance with some example embodiments.

FIG. 9 shows a flow diagram of a method of manufacture of an optical fiber mount with conductive traces in accordance with some example embodiments.

FIG. 10 shows a system that may incorporate the multi-chip packages and methods, in accordance with some example embodiments.

Like symbols in the figures indicate like elements.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

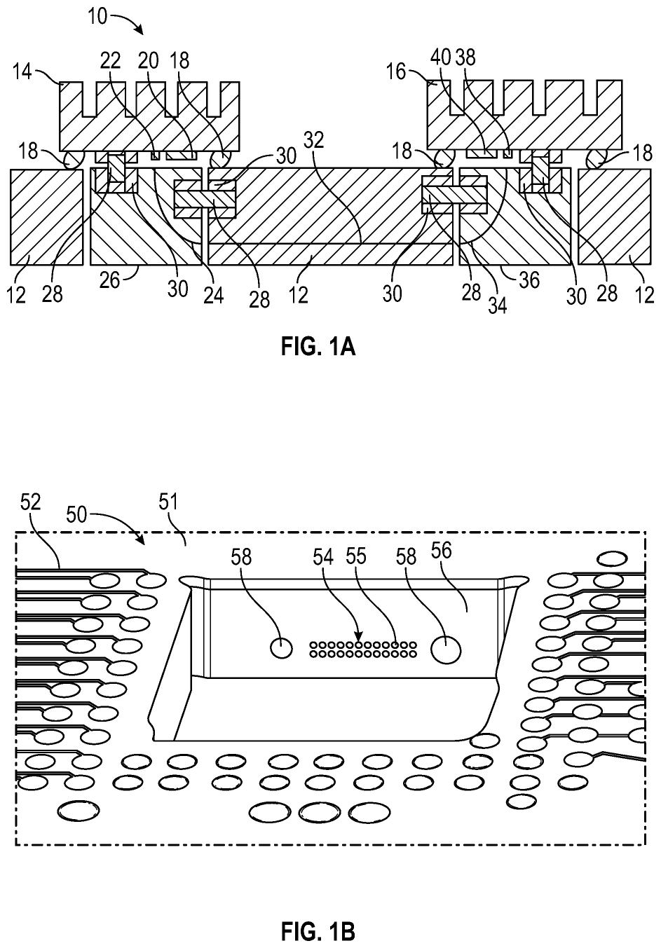

Referring now to FIG. 1A, a schematic cross-sectional view of a portion of a multi-chip package 10 includes an organic printed circuit board 12. The circuit board 12 includes two photonic integrated circuit (PIC) devices 14, 16 mounted thereon. The PIC devices 14, 16 are each mounted on the circuit board 12 via corresponding arrays of solder balls 18.

The transmitting PIC device 14 includes a driver IC 20 and a vertical cavity surface emitting laser (VCSEL) 22. The VCSEL 22 transmits light to an optical fiber array 24 in a 90° bent fiber block 26. The fiber block 26 is retained on the circuit board 12 and aligned via guide pins 28 inserted in corresponding ferrules 30.

Light signals emitted by the optical fiber array 24 are transmitted along optical fibers 32 to an optical fiber array 34 in a corresponding 90° bent fiber block 36, which is aligned via guide pins 28 inserted in corresponding ferrules 30. The optical signals along the optical fiber array 34 are transmitted to a photonic detector 38 on the receiver PIC 16, and then processed by a receiver IC 40.

An example circuit board 50 is shown schematically in FIG. 1B, which includes conductive traces 52 on a surface 51. A 2×12 array 54 of unclad optical fibers 55 resides below the surface 51. The optical fibers 55 are retained in a block 56 of a polymeric resin material, metal, ceramic, or the like. Guide hole ferrules 58 are used to align the optical fibers 55 in the array 54 with corresponding optical fibers (not shown in FIG. 1B) for optical coupling to devices attached to the conductive traces 52 on the circuit board 50. As shown in FIG. 1B, embedding an entire bundle of optical fibers in a block 56 for mounting in a circuit board takes up significant space in each of the x, y, and z directions, and does not allow for flexible optical fiber routing to different devices on the circuit board. For example, bulky bundled optical fiber arrays can make placement, bending, and alignment of individual optical fibers more difficult.

In one aspect, the present disclosure provides an optical fiber mount including channels that can be used to route individual clad optical fibers, or bundles of clad optical fibers, to provide optical signaling between regions of a substrate of a multi-chip package. The individual clad optical fibers, which in some examples have a diameter of about 125 microns, can be easily routed within the optical fiber mount to optically interconnect PICs or ICs mounted on the substrate. In one example, which is not intended to be limiting, a single mode optical fiber including a core and cladding, which is routed within the optical fiber mount of the present disclosure, can provide a signal propagation loss of 0.000005 dB/cm. The signal propagation loss obtainable with the optical fibers in the optical fiber mounts of the present disclosure is substantially lower than optical coupling techniques such as, for example, polymer waveguides (0.5 dB/cm), ion exchange glass waveguides (0.1 dB/cm), and laser direct write waveguides (0.1 dB/cm).

In various examples, the optical fiber mounts of the present disclosure can be formed in or on a substrate suitable for mounting of a single or multiple ICs, such as a circuit board, or can be inserted into a suitably dimensioned cavity in the substrate. A suitable network of one or more channels may be formed in the optical fiber mount for optically coupling a wide variety of optical elements such as, for example, an optical waveguide, an edge coupler, a photonic integrated circuit (PIC) device, an optical train, a fiber array unit, a detector, another optical fiber, and combinations thereof. The substrate including the optical fiber mount can further be configured to include suitable electrically conductive elements or through glass vias (TGV) for electrically connecting the ICs or PICs thereon to each other or to an underlying circuit board or other electronic device.

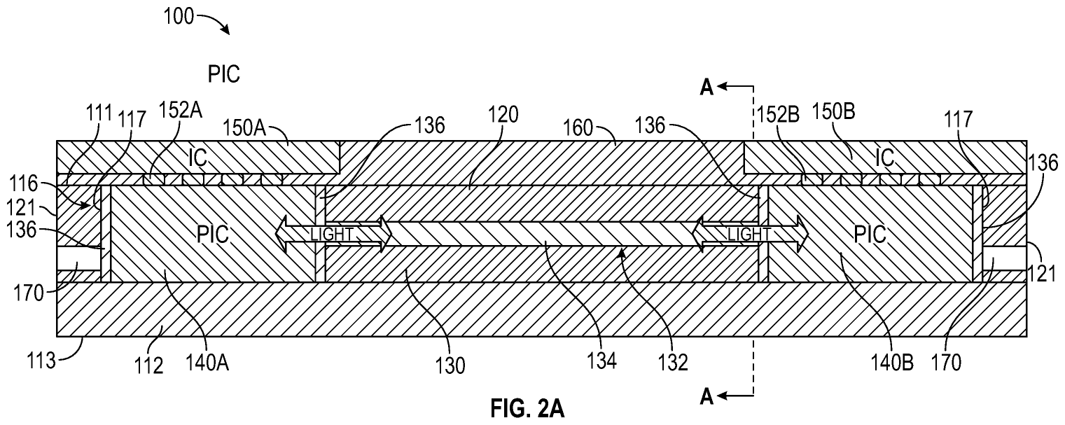

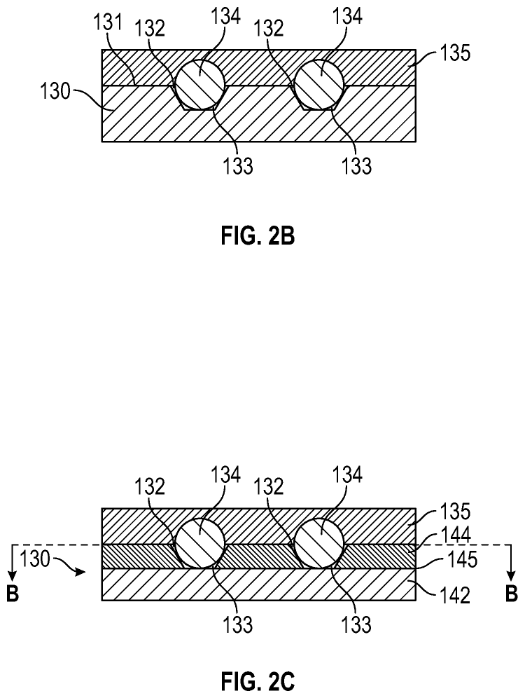

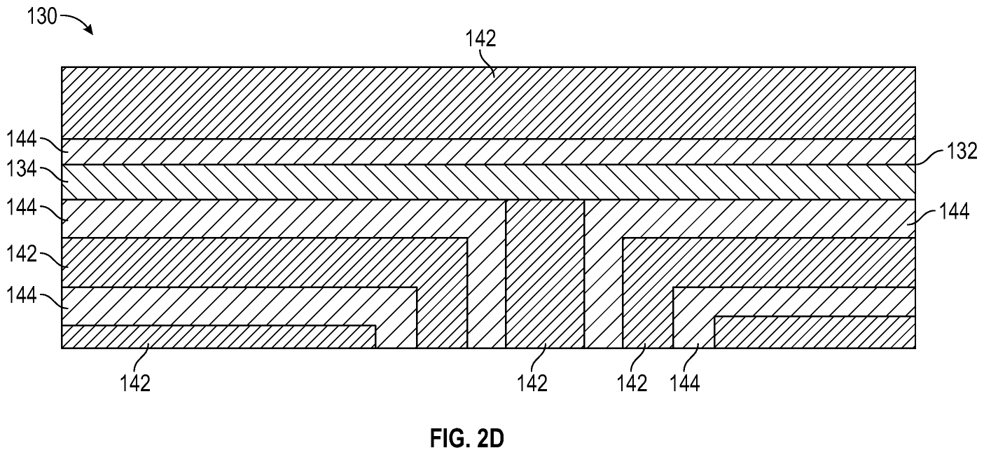

In an example shown schematically in FIG. 2A, a multi-chip package 100 includes a substrate 112 with a first major surface 111 and an opposed second major surface 113. In various examples, the substrate 112 may include any material suitable for mounting an IC thereon, and suitable examples include organic materials such as glass fiber reinforced epoxy or phenolic resins, or glass. Examples of glass materials that may be used with the described embodiments include pure silica (e.g., approximately 100% SiO₂), soda-lime glass, boro-silicate glass, alumo-silicate glass, fluoride glasses, phosphate glasses, chalcogen glasses, and the like. In addition, the major surfaces 111, 113 of the substrate 112 may optionally include surface treatments and/or coatings (not shown in FIG. 2) to improve strength and/or durability, and a glass substrate suitable for use in the embodiments described herein may also be annealed to lower internal stresses.

The substrate 112 includes a suitably dimensioned cavity 116 within the bounds of the first major surface 111 of the substrate 112. The cavity 116 includes an optical fiber mount 130. In the example of FIG. 2, the cavity 116 has a depth sufficient such that an exposed surface 120 of the optical fiber mount 130 is substantially coplanar with respect to the first major surface 111 of the substrate 112, although the dielectric mount can have any suitable dimension and in some cases the surface 120 thereof may extend above or below the first major surface 111. The optical fiber mount 130 may be mounted in the cavity 116 using any known technique such as, for example, with an adhesive.

The optical fiber mount 130 includes at least one channel 132 configured to retain a single clad optical fiber or a bundle of clad optical fibers 134. Suitable optical fibers 134 include single glass fibers each overlain with a cladding, bundles of individually clad glass fibers, or a bundle of glass fibers overlain by one or more cladding layers. In this application, the term cladding refers to a layer of material with a lower refractive index that covers the glass core of an optical fiber. The glass core of the optical fiber thus has a higher refractive index than the cladding around it. It should be understood that the cladding can include one or more layers.

The optical fibers 134 can include single mode fibers (SMF) or multi-mode fibers (MMF). The diameters of the optical fibers 134 are not particularly limited, but in some examples the individual optical fibers (including all cladding layers thereon) have a diameter of greater than about 50 microns, or greater than about 100 microns, or greater than about 125 microns.

In some examples, the channel 132 is substantially linear and extends along a direction substantially parallel to a plane of the first major surface 111 and the second major surface 113 of the substrate 112. In another example, the channel 132 is substantially linear and extends along a direction substantially normal to the plane of the major surfaces 111, 113. However, the channel 132 can have any suitable configuration needed for routing the clad optical fibers 134 mounted therein to provide optical coupling between optical elements mounted in the cavity 116 or on the first major surface 111 or the second major surface 113 of the substrate 112. For example, the channel 132 can include non-linear arcuate portions as needed to route the clad optical fibers 134. In some examples, the channels 132 are discontinuous, which means that the channels 132 can include breaks or spaces in the channel features.

Referring now to the schematic diagram in FIG. 2B, which is a view taken along line A-A of FIG. 2A, and is not to scale, in some examples the optical fiber mount 130 can include channels 132 formed in a dielectric material, which is this application includes materials that are less conductive than materials used for electrical conduction. Suitable examples include, but are not limited to, silicon oxides and nitrides, polymeric blocks and single or multi-layer films such as, for example those available from Ajinomoto Co., Tokyo, JP, under the trade designation Ajinomoto Build-up Film (ABF), prepregs, epoxy mold, glass, ceramics, and mixtures and combinations thereof.

In some examples, the channel 132 can include an adhesive 133 to securely mount the optical fibers 134. Any adhesive can be used, and epoxy adhesives have been found to be suitable. The adhesive 133 can be applied along the entire length of the channel 132, or along selected portions thereof. In some examples, the adhesive 133 can extend over multiple channels 132, and can even form a unitary layer over the optical fiber mount 130. In some examples, the adhesive 133 can extend over the individual optical fibers 134, or may be present within or along a wall of the channel 132.

In some examples, the optical fiber mount 130 can have applied thereon an optional dielectric layer 135 (not shown in FIG. 2A), which overlies all or a portion of a surface 131 including the channels 132. In some examples, the dielectric layer 135 can overlie the optical fibers 134 and the adhesive 133.

In another example shown in the schematic diagram in FIG. 2C, which is a view taken along line A-A of FIG. 2A, and is not to scale, in some examples the optical fiber mount 130 can include a support 142 formed from a dielectric material, and any of the dielectric materials referenced above can be used. An arrangement of channels 132 is formed in a conductive layer 144 on the support 142, and clad optical fibers 134 reside in all or a portion of the channels 132. The conductive layer 144, which can be formed from any suitable conductive material such as metals, metal oxides, and the like, thus forms conductive traces surrounding the optical fibers 134 (see FIG. 2D below). As discussed above with respect to FIG. 2B, the optical fiber mount 130 of FIG. 2C can optionally include a dielectric layer 135 on all or a portion of the conductive layer 144, and in some examples an adhesive 133 may be used to secure the optical fibers 134 in the channels 132. In some examples, the optical fiber mount 130 can optionally include a seed layer 145 between the support 142 and the conductive layer 144.

In another example, the optical fiber mount 130 in FIG. 2C can include a support 142 of dielectric material such as a Cu-clad laminate like fiber-reinforced epoxy, glass, silicon, silicon oxides and nitrides, ceramics, and the like. An organic dielectric film 144 can be applied on the support 142, and channels 132 can be formed in the dielectric film 144. The organic dielectric film 144 can include a single layer or multiple layers.

Referring now to FIG. 2D, which is a view taken along a line B-B of FIG. 2C, a clad optical fiber 134 resides in a channel 132 in a conductive layer 144 on the dielectric support 142. As shown in FIG. 2D, the conductive layer 144 may be patterned in any suitable way to form an arrangement of conductive traces. Some of the regions between the conductive traces form channels 132 in which optical fibers 134 are mounted. It should be understood that the traces formed in the conductive layer 144 may be used to electrically interconnect to ICs, wires, solder balls, and the like.

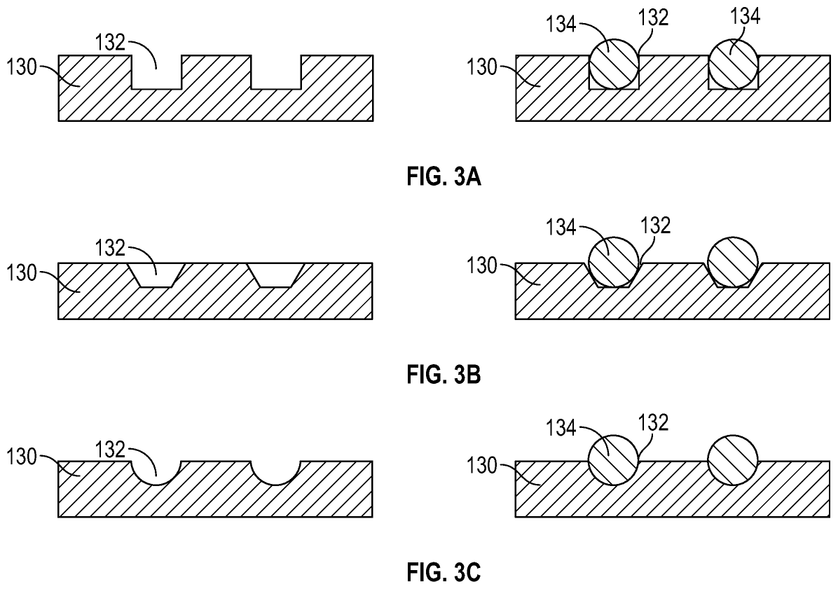

As shown schematically in FIGS. 3A-3C, the channels 132 in the optical fiber mount 130 can have a wide variety of cross-sectional shapes as needed to securely mount therein the clad optical fibers 134, and in some examples, which are not intended to be limiting, the cross-sectional shapes include rectangular (FIG. 3A), square, trapezoidal (FIG. 3B), arcuate, hemispherical (FIG. 3C), and combinations thereof.

In the embodiment of FIGS. 2A-2D, the dielectric mount 130 is formed as an insert that is secured in the cavity 116 in the substrate 112 by, for example, an adhesive layer, by soldering using solder balls or pillars, by hybrid bonding, and combinations thereof (not shown). However, in some examples, the dielectric mount 130 may be formed in a surface of the substrate 112 itself.

Referring again to FIG. 2A, the cavity 116 further includes at least one optical element configured for optical coupling to the optical fibers 134 in the dielectric mount 130. In some examples, the optical fibers 134 enable optical signaling between optical devices such as photonic integrated circuit (PIC) devices like the PIC dies or interposers 140A, 140B, which can be the same or different. In this application the term PIC refers to any silicon-based integrated circuit device that includes an optical component. In some examples, which are not intended to be limiting, PICs can include transmitting and receiving PIC dies, EICs, logic dies, combinations thereof, or stacks or modules including one or more of these components. In the example of FIG. 2A, the optical fibers 134 mounted in the optical fiber mount 130 provide optical signaling between the PIC interposers 140A, 140B.

Other suitable optical elements that may be present in the cavity 116 or the substrate 112 include, for example, optical waveguides, edge couplers, a lens or an optical train, a fiber array unit, a detector, another optical fiber or bundle thereof, and combinations thereof.

As shown in FIG. 2A, a layer 136 of an optically clear adhesive can optionally be used to mount and align the PIC interposers 140A-140B with respect to the optical fibers 134 in the optical fiber mount 130, or to mount the PIC interposers 140A, 140B along the substantially vertical walls 117 of the cavity 116.

While FIG. 2A shows the optical fiber mount 130 and the PIC interposers 140A-140B in a single cavity 116, in other examples the optical fiber mount 130 and the optical fiber elements such as PIC interposers 140A, 140B can be housed in separate cavities in the substrate.

As shown schematically in FIG. 2A, integrated circuit devices (ICs) 150A, 150B are electrically interconnected with the PIC interposers 140A, 140B via corresponding arrays of solder balls 152A, 152B using flip-chip bonding. The undersides of the ICs 150A, 150B, each include arrays of solder bumps that mate with corresponding arrays of solder bumps on the PIC interposers 140A, 140B. Once the corresponding arrays of solder bumps 152A, 152B are attached, space between the ICs 150A, 150B and the first major surface 111 of the substrate 112 may optionally be filled with an underfill material 160 such as, for example, an epoxy resin. The ICs 150A, 150B may be the same or different, and can include semiconductor devices such as, for example, an amplifier, oscillator, timer, counter, logic gate, computer memory, microcontroller or microprocessor, and the like, and combinations thereof.

The ICs 150A, 150B need not be directly electrically interconnected to the PIC interposers 140A, 140B via solder bumps, and in some examples wire bonds or electrical routing through a redistribution layer (RDL) may be used. In some examples (not shown in FIG. 2), the substrate 112 may include electrically conductive channels or electrically conductive through glass vias (TGV) that extend along a direction normal to a plane of the first major surface 111 to provide electrically interconnection between the PIC interposers 140A, 140B and the ICs 150A, 150B. In some examples (not shown in FIG. 2), the substrate 112 may optionally include electrically conductive channels to provide electrical interconnection between the PIC interposers 140A, 140B and another component, or between the ICs 150A, 150B and another component.

In some examples, the substrate 112 can optionally include optical waveguides 170 that provide optical interconnection between the PIC interposers 140A, 140B and another optical component. As shown schematically in FIG. 2A, in some examples the optical waveguides 170 extend along a direction substantially parallel to a plane of the major surface 111 of the substrate 112. In some examples, the optical waveguides 170 extend to an edge 121 of the substrate 112, and can provide optical coupling between the multi-chip package 100 and another optical component such as, for example, a detector, an array of optical fibers, or another multi-chip package (not shown in FIG. 2).

In some examples, the PIC interposers 140A, 140B may optionally include optical waveguides or other components (not shown in FIG. 2A) to provide vertical optical coupling to another optical component such as, for example, a detector, an array of optical fibers, or another multi-chip package.

While not shown in FIG. 2A, in some examples the substrate 112 may optionally include solder balls or other connectors on the second major surface 113 thereof to provide electrical interconnection with another semiconductor component, circuit board, or multi-chip package. The second major surface 113 of the substrate 112 may also optionally include additional layers (not shown in FIG. 2A) needed for connection to another semiconductor component, circuit board, or multi-chip package.

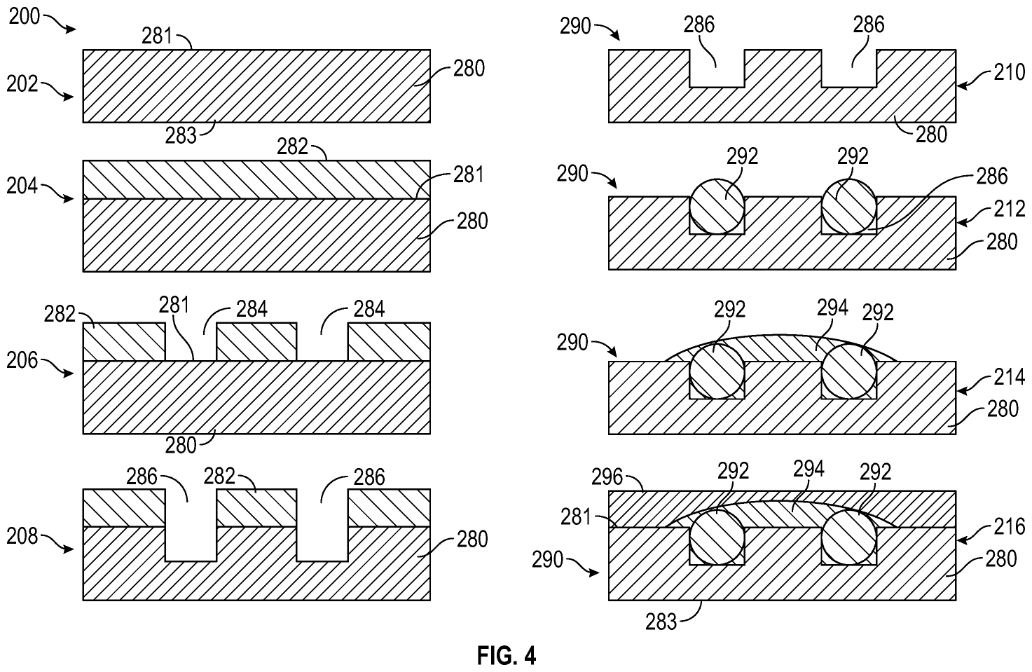

Referring now to FIG. 4, a schematic diagram is shown to outline an example method 200 for fabricating an example dielectric optical fiber mount of the present disclosure. As noted above, the optical fiber mount may be a substrate suitable for mounting an IC, such as a circuit board, or may be an insert configured for insertion into a substrate.

As shown in step 202, a silicon substrate 280 such as, for example, Si, SiOₓ, (for example, SiO₂), silicon nitride, and the like, includes a substantially planar first major surface 281 and a substantially planar opposed second major surface 283.

In step 204, a mask 282 of a metal or a resist material is deposited on the major surface 281 of the substrate 280.

In step 206, the mask 282 is patterned to form an arrangement of channel regions 284, exposing areas of the first major surface 281 of the substrate 280.

In step 208, an etchant is applied to the channel regions 284 to etch the major surface 281 of the substrate 280 and form corresponding channels 286 extending below the major surface 281 thereof. A wet or a dry etchant, or a combination thereof, can be used. As noted above, the channels 286 can be continuous or discontinuous, and can include linear portions, arcuate portions, bends, and the like.

In step 210, the mask 282 is removed to form the dielectric mount 290 including the channels 286.

In step 212, individual or bundled optical fibers 292 are placed in the channels 286, and in step 214 an adhesive 294 is applied in the channels 286 prior to optical fiber placement, or over all or a portion of the optical fibers 292 after optical fiber placement, or a combination thereof. While the example in FIG. 4 shows the adhesive 294 applied over multiple optical fibers 292, in some examples the adhesive 294 can be applied on individual optical fibers in a single channel 286.

In step 216, in some examples an optional dielectric layer 296 can be deposited on the first major surface 281 of the substrate 280 to overlie the optical fibers 292 and the adhesive 294. Additional layers may optionally be applied on the dielectric layer 296, or on the second major surface 283 of the substrate 280, to build up the substrate 280 in preparation for additional process steps.

In an alternative process (not shown in FIG. 4), the grooves 286 formed via the etching steps 204-208 may be formed by laser engraving the first major surface 281 of the substrate 280 to form the grooves 286.

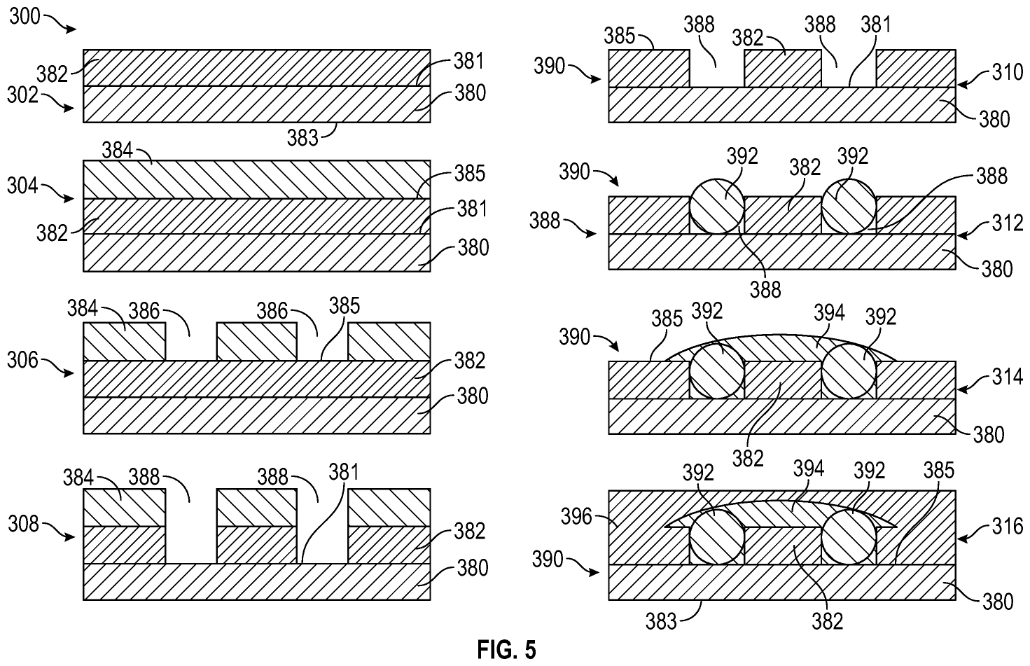

Referring now to FIG. 5, a schematic diagram is shown to outline another example method 300 for fabricating an example dielectric optical fiber mount of the present disclosure. As noted above, the optical fiber mount may be a substrate suitable for mounting an IC device, such as a circuit board, or may be an insert configured for insertion into a substrate.

In step 302 of the method 300, a support 380 includes a first major surface 381 and a second major surface 383. Suitable materials for the support 380 include, but are not limited to, Cu-clad laminates such as fiber-reinforced epoxy, glass, silicon oxides and nitrides, ceramics, and the like. An organic dielectric film 382 is applied on the first major surface 381 of the substrate 380. The organic dielectric film 382 can include a single layer or multiple layers.

In step 304, a mask 384 is deposited on an exposed major surface 385 of the organic dielectric film 382. Suitable materials for the mask 384 include hard masks (for example, a metal) or soft masks (for example, a resist).

In step 306, the mask 384 is patterned to expose portions of the surface 385 of the organic dielectric film 382 to form an arrangement of channel regions 386.

In step 308, the organic dielectric film 382 is etched down to the surface 381 of the substrate 380 to form an arrangement of channels 388 corresponding to the channel regions 386. A wet or dry etch, or a combination thereof, can be used.

In step 310, the mask layer 384 is removed to expose the surface 385 of the organic dielectric film 382 and form the dielectric mount 390.

In step 312, optical fibers 392 or bundles thereof are placed in the channels 388, and in step 314 an adhesive 394 is applied to mount the optical fibers 392. The adhesive 394 may be applied in the channels 386 prior to optical fiber placement, or over all or a portion of the optical fibers 392 after optical fiber placement, or a combination thereof. While the example in FIG. 5 shows the adhesive 394 applied over multiple optical fibers 392, in some examples the adhesive 394 can be applied on individual optical fibers.

In step 316, in some examples an optional dielectric layer 396 can be deposited on the first major surface 385 of the organic dielectric layer 382 to overlie the optical fibers 392 and the adhesive 394. Additional layers may optionally be applied on the dielectric layer 396, or on the second major surface 383 of the substrate 380, to build up the substrate 380 in preparation for additional process steps.

In an alternative process (not shown in FIG. 5), the grooves 386 formed via the etching steps 304-308 may be formed by laser engraving the first major surface 385 of the organic dielectric layer 382 to form the grooves 386.

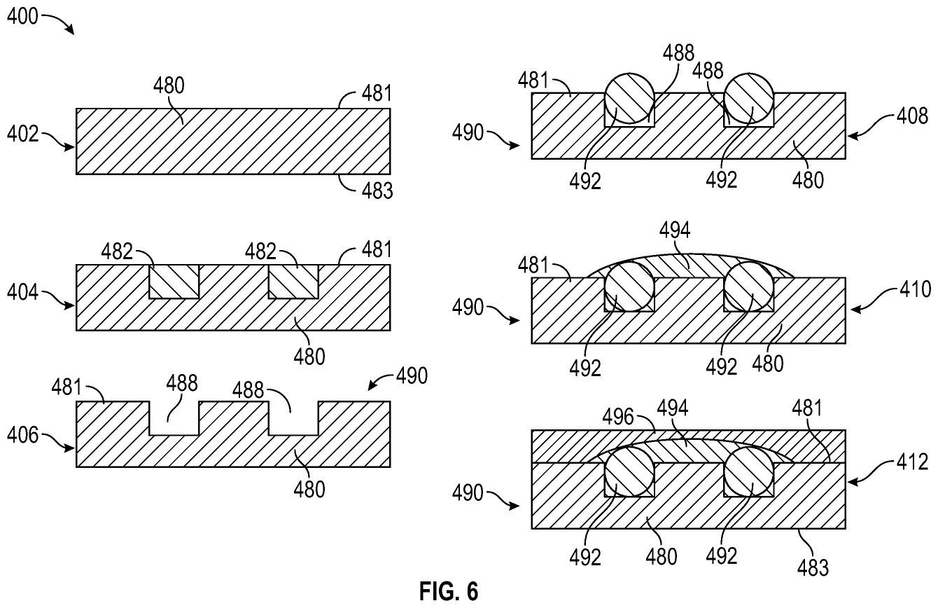

Referring now to FIG. 6, a schematic diagram is shown to outline another example method 400 for fabricating an example dielectric optical fiber mount of the present disclosure. As noted above, the optical fiber mount may be a substrate suitable for mounting an IC device, such as a circuit board, or may be an insert configured for insertion into a substrate.

In step 402 of the method 400, a glass substrate 480 includes a first major surface 481 and a second major surface 483. As noted above, suitable materials for the substrate 480 include, but are not limited to, pure silica (e.g., approximately 100% SiO₂), soda-lime glass, boro-silicate glass, alumo-silicate glass, fluoride glasses, phosphate glasses, chalcogen glasses, and the like. In addition, the major surfaces 481, 483 of the substrate 480 may optionally include surface treatments and/or coatings (not shown in FIG. 6) to improve strength and/or durability, and the substrate 480 may also optionally be annealed to lower internal stresses.

In step 404, the surface 481 of the substrate 480 is laser treated to form a pattern of channel regions 482.

In step 406, surface 481 of the substrate 480 is etched to form an arrangement of channels 488 in the laser treated channel regions 482 and create the dielectric mount 490. As noted above, a wet or dry etch, or a combination thereof, can be used.

In step 408, optical fibers 492 or bundles thereof are placed in the channels 488, and in step 410 an adhesive 494 is applied to mount the optical fibers 492. The adhesive 494 may be applied in the channels 486 prior to optical fiber placement, or over all or a portion of the optical fibers 492 after optical fiber placement, or a combination thereof. While the example in FIG. 6 shows the adhesive 494 applied over multiple optical fibers 492, in some examples the adhesive 494 can be applied on individual optical fibers.

In step 412, in some examples an optional dielectric layer 496 can be deposited on the first major surface 481 of the substrate 480 to overlie the optical fibers 492 and the adhesive 494. Additional layers may optionally be applied on the dielectric layer 496, or on the second major surface 483 of the substrate 480, to build up the substrate 480 in preparation for additional process steps.

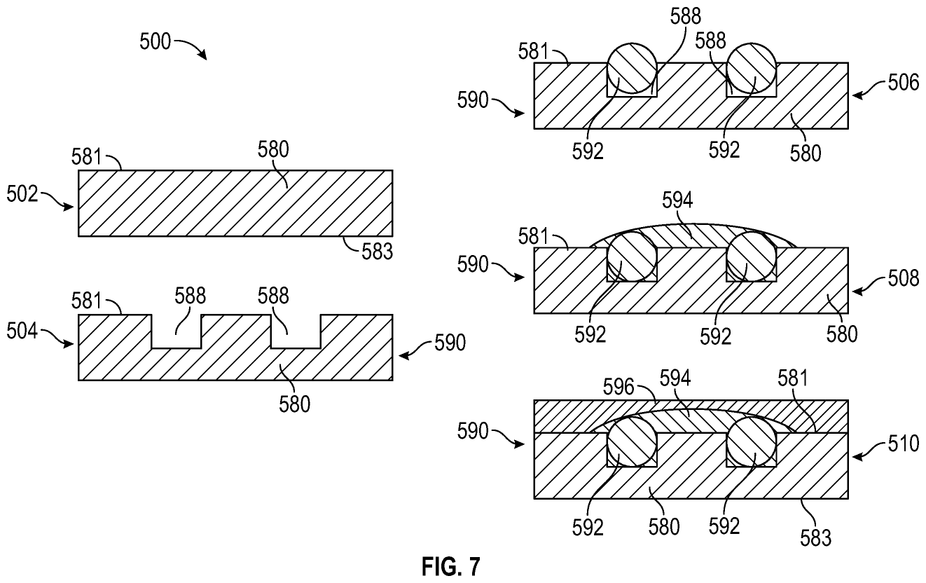

Referring now to FIG. 7, a schematic diagram is shown to outline another example method 500 for fabricating an example dielectric optical fiber mount of the present disclosure. As noted above, the optical fiber mount may be a substrate suitable for mounting an IC device, such as a circuit board, or may be an insert configured for insertion into a substrate.

In step 502 of the method 500, a ceramic substrate 580 includes a first major surface 581 and a second major surface 583. Suitable materials for the substrate 580 include, but are not limited to, inorganic, non-metallic oxide, nitride, or carbide materials.

In step 504, the surface 581 of the substrate 580 is laser engraved to form a pattern of channels 588 and create the dielectric mount 590.

In step 506, optical fibers 592 or bundles thereof are placed in the channels 588, and in step 508 an adhesive 594 is applied to mount the optical fibers 592. The adhesive 594 may be applied in the channels 588 prior to optical fiber placement, or over all or a portion of the optical fibers 592 after optical fiber placement, or a combination thereof. While the example in FIG. 7 shows the adhesive 594 applied over multiple optical fibers 592, in some examples the adhesive 594 can be applied on individual optical fibers.

In step 510, in some examples an optional dielectric layer 596 can be deposited on the first major surface 581 of the substrate 580 to overlie the optical fibers 592 and the adhesive 594. Additional layers may optionally be applied on the dielectric layer 596, or on the second major surface 583 of the substrate 580, to build up the substrate 580 in preparation for additional process steps.

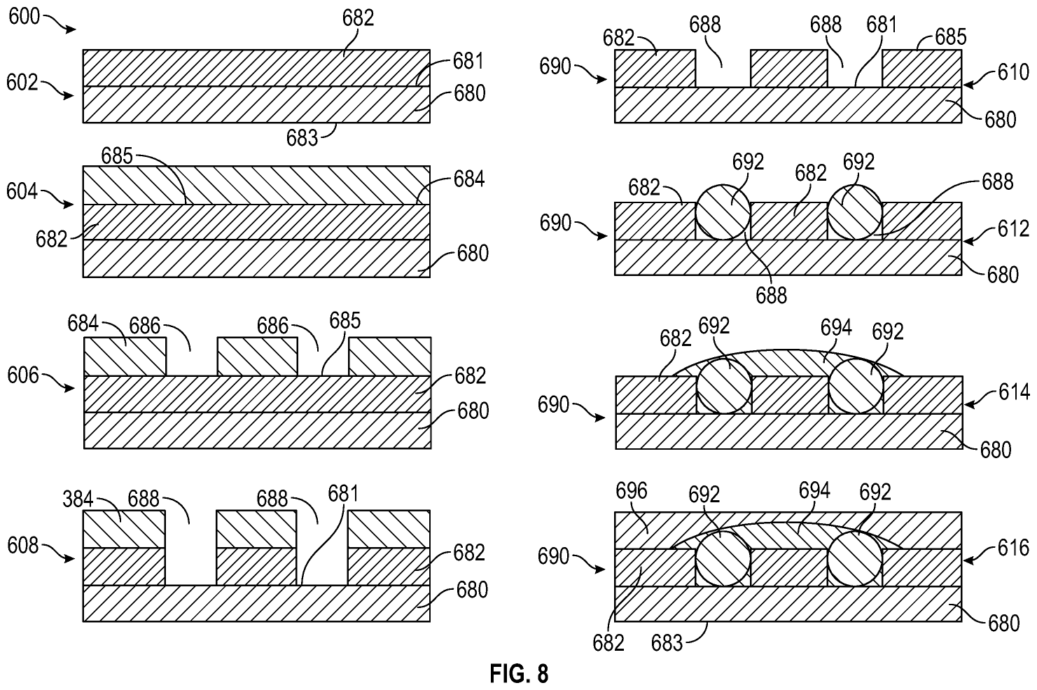

Referring now to FIG. 8, a schematic diagram is shown to outline another example method 600 for fabricating an example optical fiber mount of the present disclosure. The optical fiber mount may be a substrate suitable for mounting an IC device, such as a circuit board, or may be an insert configured for insertion into a substrate.

In step 602 of the method 600, a dielectric support 680 includes a first major surface 681 and a second major surface 683. Suitable materials for the support 680 include, but are not limited to, Cu-clad laminates such as fiber-reinforced epoxy, glass, silicon oxides and nitrides, ceramics, polymeric films, prepregs, and the like. A conductive layer 682 is applied on the first major surface 681 of the support 680. The conductive layer 682 can include a single layer or multiple layers, and suitable materials include metals, metal oxides, and the like. In one example, the conductive layer 682 can include a Cu film or foil, which may optionally be electrolytically plated.

In step 604, a resist layer 684, which may include hard or soft masks, is deposited on an exposed major surface 685 of the conductive layer 682.

In step 606, the resist layer 684 is patterned to expose portions of the surface 685 of the conductive layer 682 to form an arrangement of channel regions 686.

In step 608, the conductive layer 682 is etched down to the surface 681 of the support 680 to form an arrangement of channels 688 corresponding to the channel regions 686. As noted above, a wet or dry etch, or a combination thereof, can be used.

In step 610, the resist layer 684 is removed to expose the surface 685 of the conductive layer 682 and form the optical fiber mount 690.

In step 612, clad optical fibers 692 or bundles thereof are placed in the channels 688, and in step 614 an adhesive 694 is applied to secure the optical fibers 692. The adhesive 694 may be applied in the channels 688 prior to optical fiber placement, or over all or a portion of the optical fibers 692 after optical fiber placement, or a combination thereof. While the example in FIG. 8 shows the adhesive 694 applied over multiple optical fibers 692, in some examples the adhesive 694 can be applied on individual optical fibers.

In step 616, in some examples an optional dielectric layer 696 can be deposited on the first major surface 685 of the conductive layer 682 to overlie the optical fibers 692 and the adhesive 694. Additional layers may optionally be applied on the dielectric layer 696, or on the second major surface 683 of the support 680, to build up the support 680 in preparation for additional process steps.

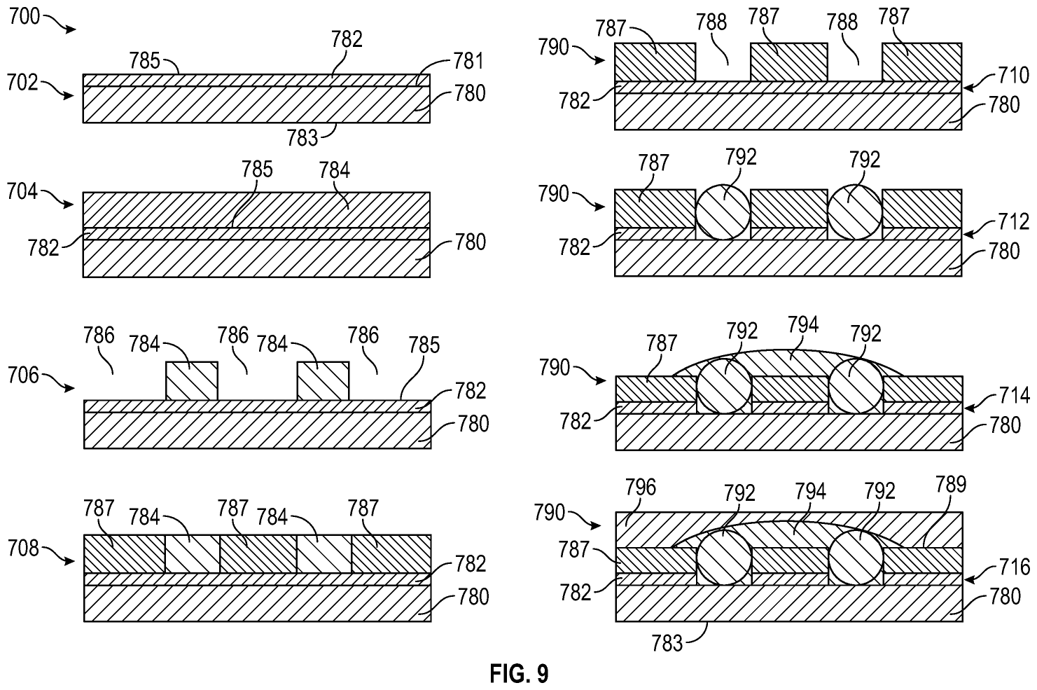

Referring now to FIG. 9, a schematic diagram is shown to outline another example method 700 for fabricating an example optical fiber mount of the present disclosure. The optical fiber mount may be a substrate suitable for mounting an IC device, such as a circuit board, or may be an insert configured for insertion into a substrate.

In step 702 of the method 700, a dielectric support 780 includes a first major surface 781 and a second major surface 783. Suitable materials for the support 780 include, but are not limited to, Cu-clad laminates such as fiber-reinforced epoxy, glass, silicon oxides and nitrides, ceramics, polymeric films, prepregs, and the like.

A seed layer 782 is applied on the first major surface 681 of the substrate 780. The seed layer 682 can include one or more layers of Cu, which may be electroless plated, sputtered Ti/Cu, and the like.

In step 704, a resist layer 784, which may include hard or soft masks, is deposited on an exposed major surface 785 of the seed layer 782.

In step 706, the resist layer 784 is patterned to expose portions of the surface 785 of the seed layer 782 to form an arrangement of voids 786.

In step 708, a conductive material is deposited on the surface 785 of the seed layer 782 in the voids 786 to form a conductive layer 780. The conductive layer 787 can include a single layer or multiple layers, and suitable materials include metals, metal oxides, and the like. In one example, the conductive layer 787 can include a Cu film, which may optionally be electrolytically plated.

In step 710, the resist 784 is stripped away to form channels 788 in the conductive layer 787 and form the optical fiber mount 790. As noted above, either wet or dry etch, or a combination thereof, can be used.

In step 712, clad optical fibers 792 or bundles thereof are placed in the channels 788, and in step 714 an adhesive 794 is applied to secure the optical fibers 792. The adhesive 794 may be applied in the channels 788 prior to optical fiber placement, or over all or a portion of the optical fibers 792 after optical fiber placement, or a combination thereof. While the example in FIG. 9 shows the adhesive 794 applied over multiple optical fibers 792, in some examples the adhesive 794 can be applied on individual optical fibers.

In step 716, in some examples an optional dielectric layer 796 can be deposited on a first major surface 789 of the conductive layer 787 to overlie the optical fibers 792 and the adhesive 794. Additional layers may optionally be applied on the dielectric layer 796, or on the second major surface 783 of the support 780, to build up the support 780 in preparation for additional process steps.

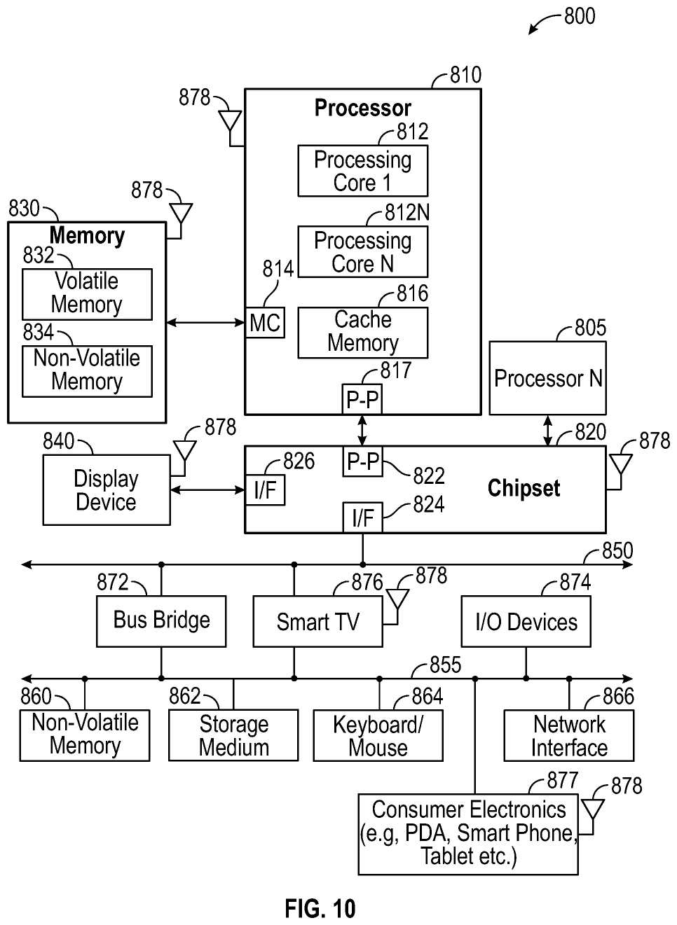

FIG. 10 illustrates a system level diagram, depicting an example of an electronic device (e.g., system) that may include a multi-chip package or system as described above. In one embodiment, system 800 includes, but is not limited to, a desktop computer, a laptop computer, a netbook, a tablet, a notebook computer, a personal digital assistant (PDA), a server, a workstation, a cellular telephone, a mobile computing device, a smart phone, an Internet appliance or any other type of computing device. In some embodiments, system 600 includes a system on a chip (SOC) system.

In one embodiment, processor 810 has one or more processor cores 812 and 812N, where 812N represents the Nth processor core inside processor 810 where N is a positive integer. In one embodiment, system 800 includes multiple processors including 810 and 805, where processor 805 has logic similar or identical to the logic of processor 810. In some embodiments, processing core 812 includes, but is not limited to, pre-fetch logic to fetch instructions, decode logic to decode the instructions, execution logic to execute instructions and the like. In some embodiments, processor 810 has a cache memory 816 to cache instructions and/or data for system 800. Cache memory 816 may be organized into a hierarchal structure including one or more levels of cache memory.

In some embodiments, processor 810 includes a memory controller 814, which is operable to perform functions that enable the processor 810 to access and communicate with memory 830 that includes a volatile memory 832 and/or a non-volatile memory 834. In some embodiments, processor 810 is coupled with memory 830 and chipset 820. Processor 810 may also be coupled to a wireless antenna 878 to communicate with any device configured to transmit and/or receive wireless signals. In one embodiment, an interface for wireless antenna 878 operates in accordance with, but is not limited to, the IEEE 802.11 standard and its related family, Home Plug AV (HPAV), Ultra-Wide Band (UWB), Bluetooth, WiMax, or any form of wireless communication protocol.

In some embodiments, volatile memory 832 includes, but is not limited to, Synchronous Dynamic Random Access Memory (SDRAM), Dynamic Random Access Memory (DRAM), RAMBUS Dynamic Random Access Memory (RDRAM), and/or any other type of random access memory device. Non-volatile memory 834 includes, but is not limited to, flash memory, phase change memory (PCM), read-only memory (ROM), electrically erasable programmable read-only memory (EEPROM), or any other type of non-volatile memory device.

Memory 830 stores information and instructions to be executed by processor 810. In one embodiment, memory 830 may also store temporary variables or other intermediate information while processor 810 is executing instructions. In the illustrated embodiment, chipset 820 connects with processor 810 via Point-to-Point (PtP or P-P) interfaces 817 and 822. Chipset 820 enables processor 810 to connect to other elements in system 800. In some embodiments of the example system, interfaces 817 and 822 operate in accordance with a PtP communication protocol such as the those available from Intel Corp., Santa Clara, CA, under the trade designation QuickPath Interconnect (QPI) or the like. In other embodiments, a different interconnect may be used.

In some embodiments, chipset 820 is operable to communicate with processor 810, 805N, display device 840, and other devices, including a bus bridge 872, a smart TV 876, I/O devices 874, nonvolatile memory 860, a storage medium (such as one or more mass storage devices) 862, a keyboard/mouse 864, a network interface 866, and various forms of consumer electronics 877 (such as a PDA, smart phone, tablet etc.), etc. In one embodiment, chipset 820 couples with these devices through an interface 824. Chipset 820 may also be coupled to a wireless antenna 878 to communicate with any device configured to transmit and/or receive wireless signals. In one example, any combination of components in a chipset may be separated by a continuous flexible shield as described in the present disclosure.

Chipset 820 connects to display device 840 via interface 826. Display 840 may be, for example, a liquid crystal display (LCD), a light emitting diode (LED) array, an organic light emitting diode (OLED) array, or any other form of visual display device. In some embodiments of the example system, processor 810 and chipset 820 are merged into a single SOC. In addition, chipset 820 connects to one or more buses 850 and 855 that interconnect various system elements, such as I/O devices 874, nonvolatile memory 860, storage medium 862, a keyboard/mouse 864, and network interface 866. Buses 850 and 855 may be interconnected together via a bus bridge 872.

In one embodiment, mass storage device 862 includes, but is not limited to, a solid-state drive, a hard disk drive, a universal serial bus flash memory drive, or any other form of computer data storage medium. In one embodiment, network interface 866 is implemented by any type of well-known network interface standard including, but not limited to, an Ethernet interface, a universal serial bus (USB) interface, a Peripheral Component Interconnect (PCI) Express interface, a wireless interface and/or any other suitable type of interface. In one embodiment, the wireless interface operates in accordance with, but is not limited to, the IEEE 802.11 standard and its related family, Home Plug AV (HPAV), Ultra-Wide Band (UWB), Bluetooth, WiMax, or any form of wireless communication protocol.

While the modules shown in FIG. 10 are depicted as separate blocks within the system 800, the functions performed by some of these blocks may be integrated within a single semiconductor circuit or may be implemented using two or more separate integrated circuits. For example, although cache memory 816 is depicted as a separate block within processor 810, cache memory 816 (or selected aspects of 816) can be incorporated into processor core 812.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### EXAMPLES

Example A. An integrated circuit package, comprising:
   a substrate comprising an integrated circuit device mounting surface; and
   at least one optical fiber mount in the substrate, wherein the optical fiber mount comprises a support having at least one optical fiber mounting channel, and wherein the optical fiber mounting channel is configured to mount at least one clad optical fiber.
Example B. The package of Example A, wherein the substrate comprises a cavity, and the optical fiber mount resides within the cavity.
Example C. The package of Example B, further comprising a dielectric layer between the optical fiber mount and the integrated circuit device mounting surface of the substrate, wherein the dielectric layer overlies at least a portion of the optical fiber mount.
Example D. The package of any of Examples A to C, wherein the optical fiber mounting channel is configured to mount a single optical fiber.
Example E. The package of any of Examples A to D, wherein the optical fiber mounting channel has a cross-sectional shape chosen from square, rectangular, trapezoidal, semicircular, and combinations thereof.
Example F. The package of any of Examples A to E, wherein the optical fiber mount comprises a dielectric material chosen from silicon, organics, glass, ceramics, and combinations thereof.
Example G. An integrated circuit package, comprising:
   a substrate comprising an integrated circuit device mounting surface; and
   at least one optical fiber mount in the substrate, wherein the optical fiber mount comprises:
   a support layer comprising a substantially planar optical fiber mounting surface; and
   an optical fiber mounting layer on the substantially planar surface of the support layer, wherein the optical fiber mounting layer comprises at least one optical fiber mounting channel with a length extending to an edge of the optical fiber mounting layer, and wherein the optical fiber mounting channel has a depth that extends to the optical fiber mounting surface of the support layer, and
   a clad optical fiber in the optical fiber mounting channel, wherein the clad optical fiber is optically coupled to an optical element at the edge of the optical fiber mounting layer.
Example H. The package of Example G, wherein the substrate comprises a cavity, and the optical fiber mount resides within the cavity.
Example I. The package of Example G or H, further comprising a dielectric layer between the optical fiber mount and the integrated circuit device mounting surface of the substrate, wherein the dielectric layer overlies at least a portion of the optical fiber mount.
Example J. The package of any of Examples G to I, wherein the optical fiber mounting channel is configured to mount a single optical fiber.
Example K. The package of any of Examples G to J, wherein the optical fiber mounting channel has a cross-sectional shape chosen from square, rectangular, trapezoidal, semicircular, and combinations thereof.
Example L. The package of any of Examples G to K, wherein the support layer comprises a dielectric material, and the optical fiber mounting layer comprises a conductive material.
Example M. The package of any of Examples G to L, wherein the support layer comprises a dielectric material chosen from silicon, glass, ceramics, and combinations thereof, and the optical fiber mounting layer comprises an organic material
Example N. The package of any of Examples G to M, wherein the clad optical fiber resides on the optical fiber mounting surface of the support layer.
Example O. The package of any of Examples G to N, further comprising an adhesive between the clad optical fiber and the optical fiber mounting surface of the support layer.
Example P. The package of any of Examples G to O, further comprising an adhesive between the clad optical fiber and a wall of the optical fiber mounting channel.
Example Q. A multi-chip package, comprising:
   a substrate comprising a first major surface and an opposed second major surface, wherein the first major surface of the substrate comprises a cavity:
   an optical fiber mount in the cavity, wherein the optical fiber mount comprises at least one optical fiber mounting channel; and
   at least one clad optical fiber in the optical fiber mounting channel, wherein the at least one clad optical fiber is optically coupled to an optical element in the substrate.
Example R. The multi-chip package of Example R, wherein the optical element is chosen from an optical waveguide, an edge coupler, a photonic integrated circuit (PIC) device, an optical train, a fiber array unit, a detector, another optical fiber, and combinations thereof.
Example S. The multi-chip package of Examples Q or R, further comprising a dielectric layer between the cavity and the first major surface of the substrate.
Example T. The multi-chip package of any of Examples Q to S, wherein the substrate further comprises at least one electrically conductive via extending along a direction substantially normal to a plane of the first major surface of the substrate.
Example U. The multi-chip package of any of Examples Q to T, further comprising a dielectric layer between the cavity and the first major surface of the substrate.
Example V. The multi-chip package of any of Examples Q to U, wherein the optical fiber mount comprises a dielectric material chosen from silicon, organics, glass, ceramics, and combinations thereof.
Example W The multi-chip package of any of Examples Q to V, wherein the optical fiber mount comprises:
   a dielectric support; and
   an optical fiber mounting layer on the dielectric support, wherein the optical fiber mounting layer comprises the optical fiber mounting channel.
Example X. The multi-chip package of Example W, wherein the optical fiber mounting layer comprises a material chosen from organics and metals.
Example Y. A system, comprising:
   a plurality of multi-chip packages, wherein each multi-chip package comprises:
   a substrate having mounted therein:
   at least one photonic integrated circuit (PIC) device configured to electrically connect with, or optically couple to, at least one integrated circuit device, and
   an optical fiber mount, wherein the optical fiber mount comprises at least one optical fiber mounting channel, and
   at least one clad optical fiber in the optical fiber mounting channel, wherein the at least one clad optical fiber is optically coupled between the at least one PIC device and at least one fiber array unit, wherein the fiber array unit provides optical coupling between at least two multi-chip packages in the plurality of multi-chip packages.
Example Z. The system of Example Y, wherein at least some of the multi-chip packages comprise a substrate having a cavity, and the optical fiber mount resides within the cavity.
Example AA. The system of Examples Y to Z, wherein the PIC device resides within the cavity.
Example BB. The system of any of Examples Y to AA, further comprising an adhesive between the at least one clad optical fiber and the optical fiber mounting channel.
Example CC. A method for optically coupling integrated circuit devices on a substrate, the method comprising:
   inserting an optical fiber mount in the substrate, wherein the optical fiber mount comprises a plurality of channels each configured to mount at least one clad optical fiber, and
   optically coupling the integrated circuit devices via the at least one optical fiber in the dielectric mount.

We claim:

1. An integrated circuit package, comprising:
a substrate comprising an integrated circuit device mounting surface; and
at least one optical fiber mount in the substrate, wherein the optical fiber mount comprises a support having at least one optical fiber mounting channel, and wherein the optical fiber mounting channel is configured to mount at least one clad optical fiber.

2. The package of claim 1, wherein the substrate comprises a cavity, and the optical fiber mount resides within the cavity.

3. The package of claim 2, further comprising a dielectric layer between the optical fiber mount and the integrated circuit device mounting surface of the substrate, wherein the dielectric layer overlies at least a portion of the optical fiber mount.

4. The package of claim 1, wherein the optical fiber mounting channel is configured to mount a single optical fiber.

5. The package of claim 1, wherein the optical fiber mounting channel has a cross-sectional shape chosen from square, rectangular, trapezoidal, semicircular, and combinations thereof.

6. The package of claim 1, wherein the optical fiber mount comprises a dielectric material chosen from silicon, organics, glass, ceramics, and combinations thereof.

7. An integrated circuit package, comprising:
a substrate comprising an integrated circuit device mounting surface; and
at least one optical fiber mount in the substrate, wherein the optical fiber mount comprises:
a support layer comprising a substantially planar optical fiber mounting surface; and
an optical fiber mounting layer on the substantially planar surface of the support layer, wherein the optical fiber mounting layer comprises at least one optical fiber mounting channel with a length extending to an edge of the optical fiber mounting layer, and wherein the optical fiber mounting channel has a depth that extends to the optical fiber mounting surface of the support layer, and
a clad optical fiber in the optical fiber mounting channel, wherein the clad optical fiber is optically coupled to an optical element proximal the edge of the optical fiber mounting layer.

8. The package of claim 7, wherein the substrate comprises a cavity, and the optical fiber mount resides within the cavity.

9. The package of claim 8, further comprising a dielectric layer between the optical fiber mount and the integrated circuit device mounting surface of the substrate, wherein the dielectric layer overlies at least a portion of the optical fiber mount.

10. The package of claim 7, wherein the optical fiber mounting channel is configured to mount a single optical fiber.

11. The package of claim 7, wherein the optical fiber mounting channel has a cross-sectional shape chosen from square, rectangular, trapezoidal, semicircular, and combinations thereof.

12. The package of claim 7, wherein the support layer comprises a dielectric material, and the optical fiber mounting layer comprises a conductive material.

13. The package of claim 7, wherein the support layer comprises a dielectric material chosen from silicon, glass, ceramics, and combinations thereof, and the optical fiber mounting layer comprises an organic material.

14. The package of claim 7, wherein the clad optical fiber resides on the optical fiber mounting surface of the support layer.

15. The package of claim 7, further comprising an adhesive between the clad optical fiber and the optical fiber mounting surface of the support layer.

16. The package of claim 7, further comprising an adhesive between the clad optical fiber and a wall of the optical fiber mounting channel.

17. A system, comprising:
a plurality of multi-chip packages, wherein each multi-chip package comprises:
a substrate having mounted therein:
at least one photonic integrated circuit (PIC) device configured to electrically connect with, or optically couple to, at least one integrated circuit device, and
an optical fiber mount, wherein the optical fiber mount comprises at least one optical fiber mounting channel, and
at least one clad optical fiber in the optical fiber mounting channel, wherein the at least one clad optical fiber is optically coupled between the at least one PIC device and at least one fiber array unit, wherein the fiber array unit provides optical coupling between at least two multi-chip packages in the plurality of multi-chip packages.

18. The system of claim 17, wherein at least some of the multi-chip packages comprise a substrate having a cavity, and the optical fiber mount resides within the cavity.

19. The system of claim 18, wherein the PIC device resides within the cavity.

20. The system of claim 17, further comprising an adhesive between the at least one clad optical fiber and the optical fiber mounting channel.
